(19) United States
(12) Patent Application Publication
(10) Pub. No.: US 2025/0215859 A1
(43) Pub. Date: Jul. 3, 2025

(54) METHOD OF REPLACING BEARING GREASE IN A WIND TURBINE

(71) Applicant: Renew Energy Maintenance, LLC, Sioux Falls, SD (US)

(72) Inventors: Michael Sebert, Howard, SD (US); Gary David Cavigielli, Howard, SD (US); Michael Paul Feltman, Sioux Falls, SD (US)

(21) Appl. No.: 18/960,206

(22) Filed: Nov. 26, 2024

Related U.S. Application Data
(60) Provisional application No. 63/615,432, filed on Dec. 28, 2023.

(51) Int. Cl. F03D 80/70; F03D 80/55

(52) U.S. Cl. CPC F03D 80/709; F03D 80/55

(57) ABSTRACT

Methods and devices for replacing used bearing grease in a main bearing of a wind turbine. Methods for purging used bearing grease from a main bearing of a wind turbine in an up-tower arrangement without removing the main bearing cover. Methods for purging used bearing grease from a main bearing of a wind turbine in an up-tower arrangement while rotating the main shaft and main bearing.

### CROSS-REFERENCE TO RELATED APPLICATIONS

This application claims the benefit under 35 U.S.C. § 119 (e) to U.S. Provisional Application 63/615,432, filed Dec. 28, 2023, and entitled METHOD OF REPLACING BEARING GREASE IN A WIND TURBINE, which is hereby incorporated by reference in its entirety.

### FIELD

The present disclosure relates generally to a method of replacing grease in a main bearing of a wind turbine.

### BACKGROUND

Wind turbines are a renewable energy source designed to convert energy from wind into electrical energy. Wind turbines tend to be very large structures having long blades attached to a main shaft supported by a main bearing that enables the shaft to rotate about a generally horizontal axis. Due to their large size and expense, regular maintenance of wind turbines, including lubrication of the main bearings, is important to maintain operational readiness, minimize down-time for repairs or replacements, and maximize the longevity of the wind turbine.

Current methods of cleaning/purging the main bearing of a wind turbine (in conjunction with replacing and/or refilling the main bearing with new lubricant) require removal of the main bearing cover to access the main bearings, which is a time-consuming, expensive, and/or difficult process due to the large size and weight of the main bearing cover. There is a need in the art for improved methods of removing and/or replacing lubricant (e.g., grease) from the main bearings of wind turbines.

### SUMMARY

In general, this disclosure is directed to a method of replacing the bearing grease in a main bearing of a wind turbine and related systems. These methods can include removing used grease and adding in new grease.

The methods described herein may help facilitate up-tower maintenance and/or repair of wind turbines. Up-tower maintenance and/or repair of wind turbines can be advantageous, as it reduces the need for movement of large turbine components and related equipment. This can reduce associated costs, as well as the reduce the time required to complete such procedures.

Certain embodiments of this disclosure describe a method of purging used grease from a main bearing of a wind turbine main shaft. The method removing at least one bearing inspection plate from a main bearing cover of the wind turbine to provide a main bearing access opening without removing the main bearing cover from the main bearing. The method further includes affixing at least one adapter plate to the main bearing access opening. The method further includes delivering a cleaning fluid to the main bearing via the at least one adapter plate while causing the wind turbine main shaft to rotate. The method further includes draining the used grease from a drain port in the main bearing cover.

In a further embodiment of the method, removing the at least one bearing inspection plate from the main bearing cover of the wind turbine comprises removing the at least one bearing inspection plate from a downwind side of a housing of the main bearing.

In a further embodiment of the method, the steps of delivering the cleaning fluid to the main bearing and draining the used grease from the drain port are repeated for at least two cycles. In a further embodiment of the method, each of the at least two cycles comprises delivering 55 gallons of the cleaning fluid.

In a further embodiment of the method, the method further comprises attaching a hydraulic line to the at least one adapter plate, the hydraulic line configured to deliver the cleaning fluid to the main bearing.

In a further embodiment of the method, the method comprises inserting a borescope into the main bearing access opening. The method further comprises inspecting at least one bearing using the borescope.

In a further embodiment of the method, the method comprises stopping the rotation of the main shaft of the wind turbine. The method further comprises providing a supply of new grease to the main bearing while the rotation of the main shaft of the wind turbine is stopped. The method further comprises continuing to provide the supply of the new grease to the main bearing while causing the main shaft of the wind turbine to rotate.

Another embodiment of a method of purging used grease from a main bearing of a main shaft of a wind turbine includes drilling at least one access hole through a main bearing cover of the wind turbine to provide a main bearing access opening without removing the main bearing cover from the main bearing. The method further includes affixing at least one fitting to the main bearing access opening. The method further includes delivering a cleaning fluid to the main bearing via the at least one fitting while causing the main shaft of the wind turbine to rotate. The method further includes draining the used grease from a drain port in the main bearing cover.

In a further embodiment of the method, the method comprises affixing a manifold to the at least one fitting. Additionally or alternatively, the method further comprises attaching a hydraulic line to the at least one fitting, the hydraulic line configured to deliver a cleaning fluid to the main bearing.

In a further embodiment of the method, the method comprises attaching a drill guide to the main bearing cover. In a further embodiment of the method, the drill guide is attached at the 10 o'clock and/or 2 o'clock position.

In a further embodiment of the method, the method further comprises inserting a borescope into the main bearing access opening. The method further comprises inspecting at least one bearing using the borescope.

In a further embodiment of the method, the method further comprises inserting a plug into at least one of the access holes.

One embodiment includes a system for purging used grease from a main bearing of a main shaft of a wind turbine, comprising at least one pump. The embodiment further includes at least one fluid line configured to deliver a cleaning fluid to the main bearing of the main shaft of the wind turbine, the at least one fluid line being in operable connection with the at least one pump and a main bearing access opening of the main bearing. The embodiment further includes a drain port configured to drain used grease and/or cleaning fluid from the main bearing of the main shaft of the wind turbine.

In a further embodiment of the system, the system further comprises a heating element configured to heat the cleaning fluid.

In a further embodiment of the system, the system further comprises a drill guide configured to create the main bearing access opening. Additionally or alternatively, the system further comprises an adapter plate configured to create the main bearing access opening.

In a further embodiment of the system, the system is configured to be transported by a vehicle. The system can be used with turbines located in a variety of locations and/or terrains.

In a further embodiment of the system, the system further comprises a borescope insertable into the main bearing access opening. The borescope can be used to inspect various components of the main bearing, including, for example, the bearings.

The details of one or more examples are set forth in the accompanying drawings and the description below. Other features, objects, and advantages will be apparent from the description and the drawings appended hereto.

### BRIEF DESCRIPTION OF DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a flow diagram of an embodiment of a method for replacing grease in a main bearing of a wind turbine, in accordance with one or more examples of this disclosure.

FIG. 2A is a perspective view of a main bearing cover of a wind turbine, in accordance with one or more examples of this disclosure.

FIG. 2B is a perspective view of an adapter plate of a main bearing cover of a wind turbine, in accordance with one or more examples of this disclosure.

FIG. 3 is a perspective view of a drain of a main bearing cover of a wind turbine, in accordance with one or more examples of this disclosure.

FIG. 4 is a flow diagram of an embodiment of a method for replacing grease in a main bearing of a wind turbine, in accordance with one or more examples of this disclosure.

FIG. 5 is a perspective view of a main bearing cover of a wind turbine, in accordance with one or more examples of this disclosure.

FIG. 6 is a perspective view of a main bearing cover of a wind turbine, in accordance with one or more examples of this disclosure.

FIG. 7 is a perspective view of a main bearing cover of a wind turbine, in accordance with one or more examples of this disclosure.

FIG. 8 is a flow diagram of an embodiment of a method for inspecting a main bearing of a wind turbine, in accordance with one or more examples of this disclosure.

FIG. 9 is a flow diagram of an embodiment of a method for replacing grease in a main bearing of a wind turbine, in accordance with one or more examples of this disclosure.

FIG. 10A is a perspective view of an embodiment of a vehicle usable to replace grease in a main bearing of a wind turbine, in accordance with one or more examples of this disclosure.

FIG. 10B is a perspective view of an embodiment of a vehicle usable to replace grease in a main bearing of a wind turbine, in accordance with one or more examples of this disclosure.

### DETAILED DESCRIPTION

An exemplary method of purging/cleaning used lubrication grease from the main bearing of a wind turbine is described herein according to some embodiments of this disclosure. The method may typically be performed prior to, and in preparation for, filling the main bearing with new, replacement lubricant (e.g., grease). The methods described herein are capable of being performed without removing the main bearing cover, which may facilitate performing an “up-tower” process; that is, the purging/cleaning of grease may be performed on-site without removing the main bearing cover, which can significantly reduce the time and cost associated with performing such procedures.

The methods of purging/cleaning used lubrication grease can be completed by a system, as will be discussed in greater detail further below. For example, the system can include at least one pump, at least one fluid line, and a drain port. The fluid line can be configured to deliver a cleaning fluid to the main bearing of the main shaft of the wind turbine. The fluid line can be operably connected with the pump and main bearing access opening of the main bearing. The drain port can be configured to drain used grease and/or cleaning fluid from the main bearing of the main shaft of the wind turbine.

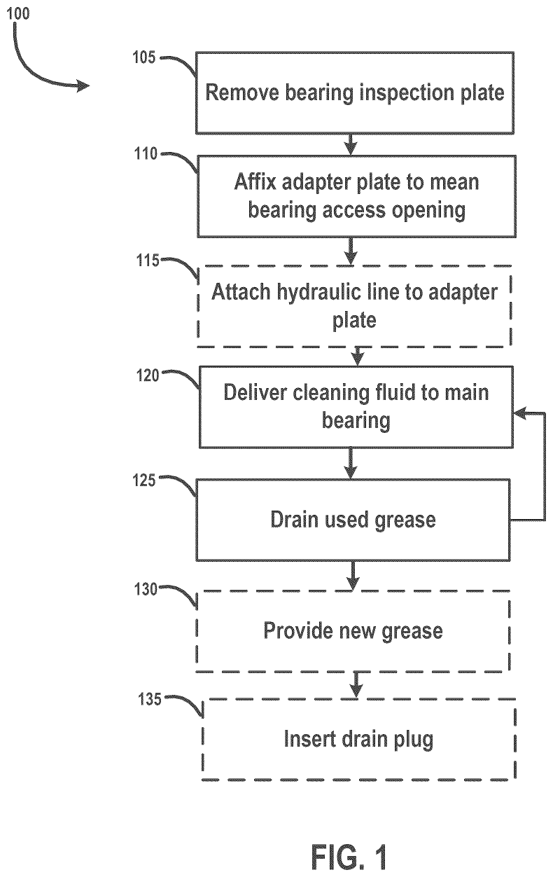

FIG. 1 is of a method of replacing grease in the main bearing of a wind turbine (Step 100). The method can include removing at least one bearing inspection plate from a main bearing cover of the wind turbine to provide a main bearing access opening without removing the main bearing cover from the main bearing (Step 105), affixing at least one adapter plate to the main bearing access opening (Step 110), delivering a cleaning fluid to the main bearing via the at least one adapter plate while causing the wind turbine main shaft to rotate (Step 120), and draining the used grease from a drain port in the main bearing cover (Step 125).

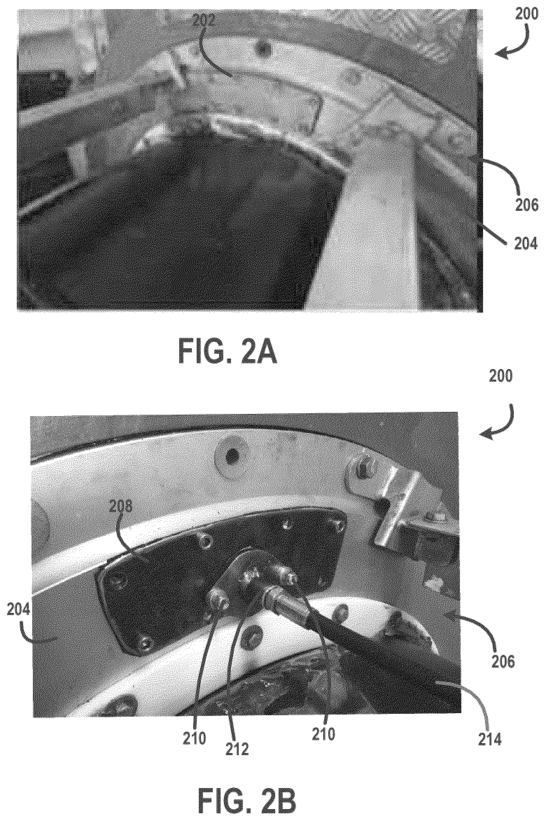

FIG. 2A shows an apparatus 200 including a bearing inspection plate 202 attached to the main bearing housing. Installing an adapter plate 208 on the main bearing housing 204 can first involve removing one or more bearing inspection plates 202 from the main bearing housing/cover 204, while leaving the main bearing housing 204 installed in place. In some cases, this can involve removing bearing inspection plates 202 from the downwind side 206 of the main bearing housing 204.

FIG. 2B shows an apparatus 200 including an adapter plate 208 attached to the main bearing housing 204. Once the bearing inspection plates 202 have been removed, the adapter plate(s) 208 can be affixed to the inspection plate 202 using at least one mechanical fastener 210. The method can include tightening the associated bolts or fasteners 210.

In some embodiments, the adapter plate 208 that is used may be specific to a certain brand/model of wind turbine. For example, adapter plates 208 may be provided that are specific to a Siemens 2.3 wind turbine and would be installed to replace the removed bearing inspection plates 202 in such specific situations. Other model-specific adapter plates 208 could be provided, as would be apparent to one of ordinary skill in the art. The model-specific adapter plates 208 may vary from each other in terms of size, shape, or fastener arrangement, for example; in each case, they would be intended to cover and seal the port or opening created by removal of the corresponding bearing inspection plate 202.

The method of replacing bearing grease in a wind turbine may include installation of hydraulic flushing lines 214. For example, in one embodiment, installing hydraulic flushing lines 214 may involve attaching one or more hydraulic lines (or hoses) 214 to the adapter plate(s) 208. In some embodiments, the hydraulic lines 214 can be attached directly to adapter plate. In other embodiments, the hydraulic lines 214 can be attached to a splitter/manifold 514 attached to the fittings to facilitate directing the cleaning fluid into the main bearing, as will be discussed in greater detail below. In some embodiments, the hydraulic lines 214 can have an end fitted to a container (not pictured) configured to house cleaning fluid. In other embodiments, the hydraulic lines 214 can be attached directly to a pump 720.

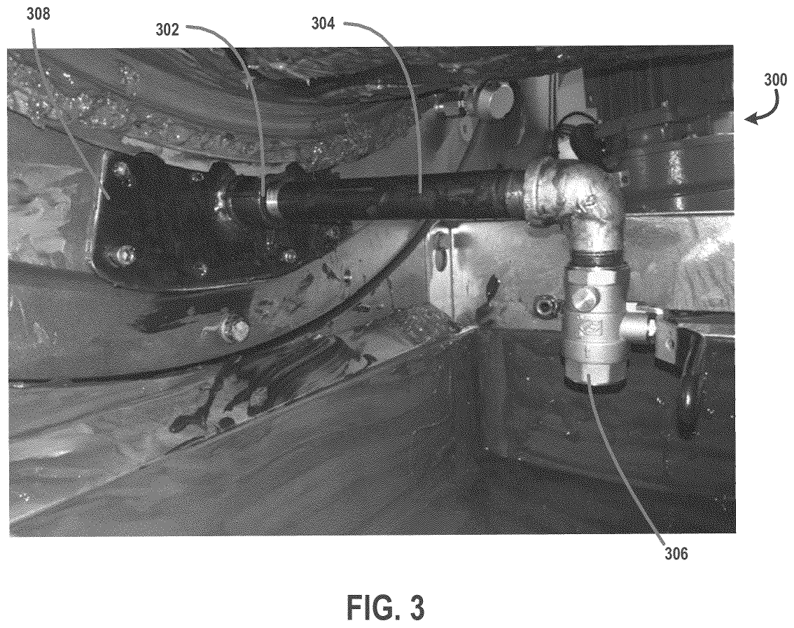

FIG. 3 shows a drain port 302 of the assembly 300. Grease and/or fluid can be pushed out of the drain port 302 during the cleaning process. In some cases, it may be desirable to place a tarp beneath the main bearing to catch the grease and fluid that is pushed out of the drain port 302. For example, in some embodiments 300, a bottom drain port 302 may be disposed at approximately the 5 o'clock position for this purpose. The drain port 302 may be disposed within an adapter plate 308.

In some embodiments, a fluid pipe 304 can be attached to the adapter plate 308. The fluid pipe 304 can be threadably disposed within the drain port 302 and can be used to direct the flow of fluid to a location to a location away from the assembly 300. Some embodiments include a valve 306, which can be used to restrict the flow of fluid therethrough.

In some further applications, a drain hose (not pictured) may be used to receive the expelled grease and/or cleaning fluid as the bearing is flushed; in some cases, such a drain hose may be provided with a suction force (e.g., from a pump 720) to suction the expelled grease and/or cleaning fluid from the tarp either during or following the grease purging process. The pump 720 can be located up-tower for purposes of changing the grease. In other embodiments, the pump 720 can be located at a down-tower location, such as on a vehicle 1000 located near the turbine.

When the above-mentioned steps have been completed and the system is ready for the grease purging process to begin, it is desirable for the turbine to be rotating/spinning at a relatively slow speed. For example, it has been determined that, in some cases, a very slow rotation of the turbine blades and/or main shaft may correspond to a rotation speed of approximately 50 RPM as measured at the high-speed output shaft of the gearbox, or “H.S. shaft.” Measuring or monitoring the speed of rotation of the H.S. shaft in this manner may provide an easier and/or more convenient way for the operator/technician to determine and assess the corresponding speed of the rotor and turbine blades from inside the nacelle of the wind turbine. Pinwheeling the turbine slowly (e.g., under no load) will allow appropriately slow rotation of the rotor and blades of the wind turbine, but the blades may have to be pitched slightly to get rotation.

In some cases, it may be desirable to run multiple rounds or cycles of flushing/purging; for example, in some specific examples, three flushing cycles may be employed, using 55 gallons of flushing agent per cycle through the main bearing housing 204. The exact quantities of flushing agent to be used and the number of cycles to run could be varied, of course; these numbers are provided for exemplary purposes only.

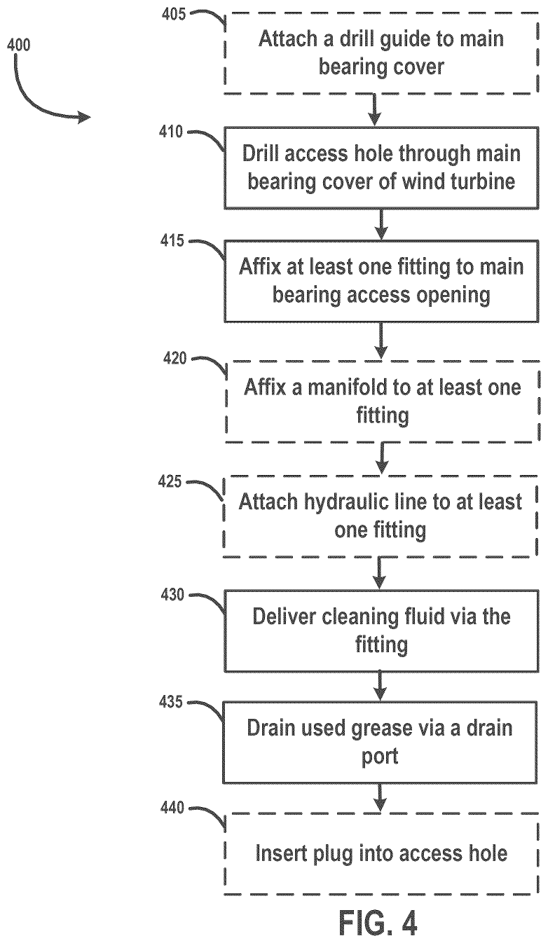

FIG. 4 shows such an alternate embodiment of the method (Step 400). In another embodiment of the method, the method can include drilling at least one access hole through a main bearing cover of the wind turbine to provide a main bearing access opening without removing the main bearing cover from the main bearing (Step 410), affixing at least one fitting to the main bearing access opening (Step 415), delivering a cleaning fluid to the main bearing via the at least one fitting while causing the main shaft of the wind turbine to rotate (Step 430), and draining the used grease from a drain port in the main bearing cover (Step 435). Such an exemplary embodiment of the method can be used with any of the systems, techniques, and methods described above with respect to purging used grease and providing cleaning fluid in FIGS. 1-3.

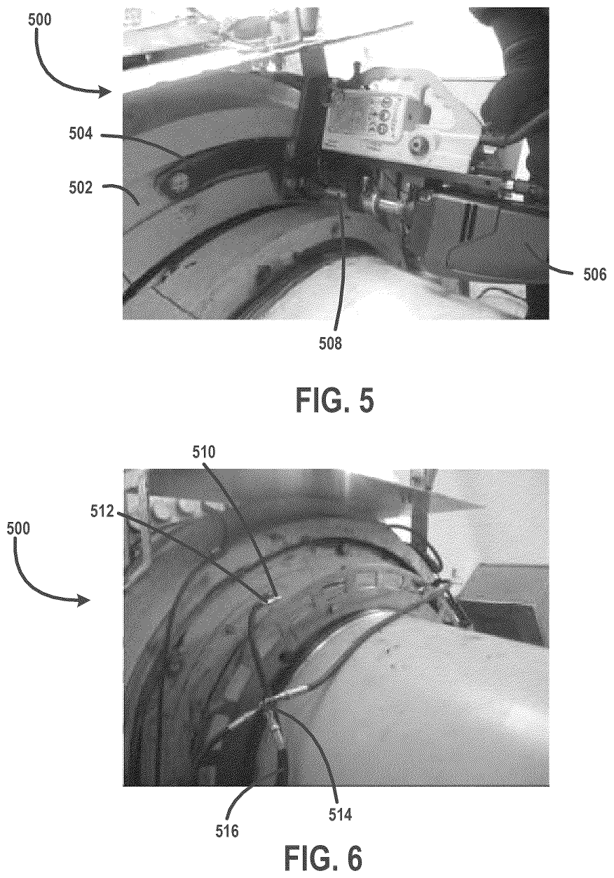

Some embodiments of the method can include attaching a drill guide to the main bearing cover to facilitate the drilling of the access hole (Step 405). FIG. 5 shows an exemplary embodiment of an assembly 500 on which a drill guide 504 can be used when drilling a hole into the main bearing covering 502. The drill guide 504 can be generally shaped such that it can rest at and/or around the location on the main bearing cover 502. In some embodiments, the drill guide 504 can be affixed to the main bearing covering 502. The drill guide 504 can be configured to allow the passage of a drill bit 508 of a drill 506 therethrough, allowing a user to drill an access port in the main bearing housing 502.

The holes can be drilled in various configurations on the main bearing housing 502. A user can use a drill guide 504 to assist in drilling the holes. For example, in one particular method, a drill guide plate 504 can be attached to the main bearing cover at approximately the 10 o'clock and 2 o'clock positions to facilitate drilling holes that provide access to the main bearings through the main bearing cover 502. The exact location or locations could vary; for example, care should be taken to ensure that the drilled holes are not positioned to coincide with a bolt or other fastener (e.g., a bolt holding the seal retainer ring).

As shown in FIG. 4, in some embodiments of the method(s), the method(s) can include installing fittings to the holes for delivering the cleaning fluid (Step 415). Further embodiments of the method can include attaching a hydraulic line to the at least one fitting (Step 425). Similarly, in embodiments including an adapter plate, the method can include attaching a hydraulic line to an adapter plate (Step 115). FIG. 6 shows an embodiment 500 including an exemplary tap 510 to which such fittings 512 can be attached. In some embodiments, the fittings (or “jets”) 512 are screwed into place, and a manifold or splitter 514 is attached to the fittings to direct the cleaning fluid into the various holes (Step 420). The manifold or splitter 514 can be configured to be attached to a hydraulic flushing line 516. In some embodiments, such as the adapter plate of FIG. 2B, the adapter plate(s) 208 may be equipped with fittings (or “jets”) 212, such manifold or splitter 514 may be configured to be attached to the fittings on the adapter plates to thereby direct the cleaning fluid through the adapter plate 208 and into the main bearing, according to certain embodiments. This can reduce the amount of equipment needed to complete the up-tower procedure, as use of a manifold or splitter 514 can reduce the quantity of tubing or lines needed in the up-tower maintenance and/or repair.

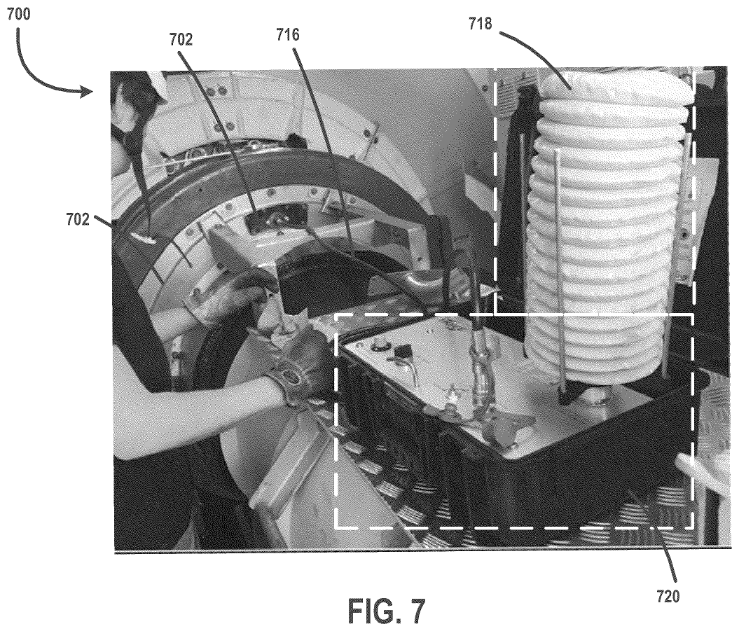

FIG. 7 shows an exemplary system 700 including a hydraulic flushing line 716. The method of replacing bearing grease in a wind turbine may include installation of hydraulic flushing lines 716 (Step 425 of FIG. 4). For example, in one embodiment, installing hydraulic flushing lines 716 may involve attaching one or more hydraulic lines (or hoses) 716 that run from the truck up to the splitter/manifold 514 attached to the fittings to facilitate directing the cleaning fluid into the main bearing. In some embodiments, the hydraulic lines 716 can have an end fitted to a container (not pictured) configured to house cleaning fluid. In some embodiments, the hydraulic lines 716 can be attached directly to a pump 720.

FIG. 7 further shows various hardware configured for use with the method. Some hardware can be transported up-tower to purge grease. For example, the hardware can be a portable pump 720. Any type of portable pump 720 movable up-tower can be used. One example of a portable pump 720 that may be suitable are those produced by Hove™. In some applications, the pump can be a fixed pump. Various grease cartridges 718 can also be transported up-tower to purge grease. The grease cartridges 718 can carry varying amounts of grease. For example, in some applications, to purge grease, new grease of about up to 50 gallons can be transported up-tower. By transporting supplies such as a pump 720 or grease cartridge(s) 718 up-tower, this can reduce amount of supplies and associated transportation costs of transporting various supplies. Additionally or alternatively, a portion of the grease can be transported up-tower and used in combination with a vehicular pump and grease purging assembly.

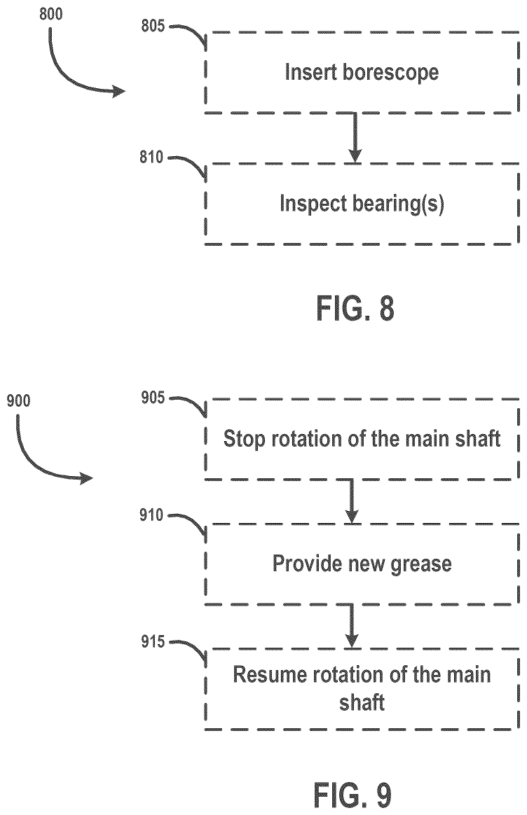

FIG. 8 shows additional steps of the methods described herein. The method 800 disclosed herein can be used while the turbine is operating at reduced speed. In some implementations, a brake is applied to, for example, stop the turbine from rotating and/or to lock the rotor into a position that allows for other tasks to be performed without movement of the rotor and blades. After the brake is applied, the splitter/manifold 514 and the jets/fittings 512 are removed from taps 510 and/or the adapter plates 208 to enable the use of a borescope (not pictured) through the ports to inspect the bearings.

FIG. 8 is a flow diagram of a method of use of the borescope (Step 800). The borescope can be inserted at the main bearing access opening (Step 805). The borescope can be used to inspect the bearings (Step 810). The use of a borescope may enable one to verify the cleanliness of bearings, as well as to take photos to document cleanliness or the condition of the bearings, and to provide an estimate of the remaining life of the bearing, for example.

In such cases, when the inspection (e.g., via borescope) is completed, plugs (not pictured) may be inserted into some or all of the holes. The plugs can prevent new grease from exiting via the holes when delivered. In some cases, plugs are inserted into all but one of the holes, and the remaining open hole is attached to a supply of new grease via a grease hose. New grease is then pumped into the main bearing (e.g., from a supply of new grease in the truck).

FIG. 9 is a flow diagram of an exemplary method of adding new grease (Step 900). The method can involve stopping rotation of the main shaft (Step 905). In some embodiments, a predetermined amount of grease can pumped into the main bearing before releasing the brake on the wind turbine (Step 910). This can be about 2 gallons to about 50 gallons of grease. In other embodiments, this can be about 8 gallons of grease. Additional grease is pumped into the main bearing while the bearing is pinwheeling (e.g., under no load conditions) at a slow speed (915). The rotation of the turbine may cause the bearings to function somewhat like a pump, allow the bearing to push new grease in and force out any remaining old lubricant from the working areas of the bearing. When the bearing is full of new grease, and the old grease has been purged and removed via the drain plug, the pumping of new grease is discontinued, a drain plug is inserted, and the grease hose is disconnected.

It may be advantageous for the turbine to be rotating while flushing/purging to enable the flushing agent (e.g., cleaning fluid, hot oil, etc.) to better clean the main bearing of the old grease/lubricant. It has been observed that rotation of the turbine while delivering heated oil to the main bearing may provide a highly effective level of cleaning and removal of old/used grease; further, it can do so without having to repeatedly move the supply of cleaning fluid to a series of different injection points in order to get all areas of the main bearing clean.

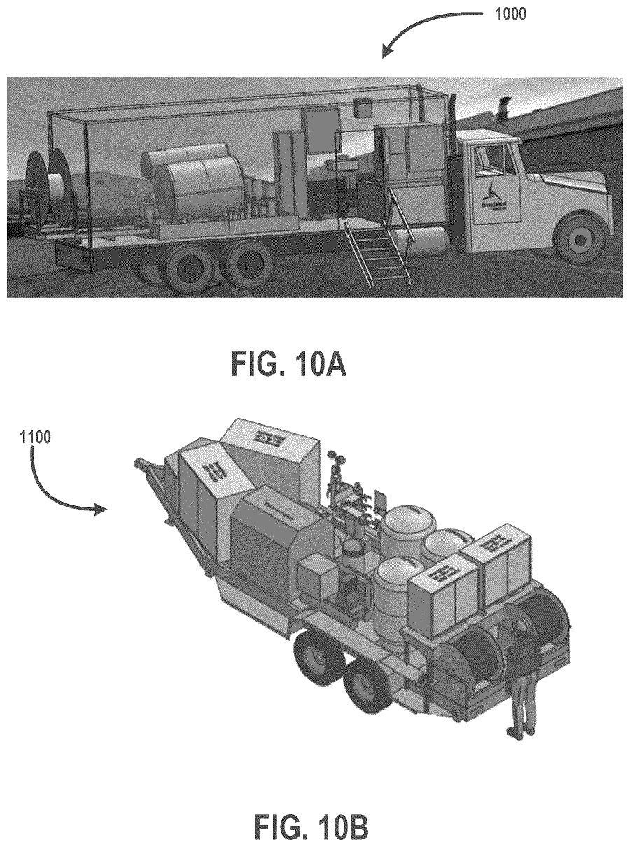

In the exemplary methods described herein, the wind turbine is shut down following standard procedures, and a truck and/or trailer may be employed to bring required supplies to the on-site maintenance location. FIG. 10A shows such an exemplary truck 1000 and FIG. 10B shows such an exemplary trailer 1100. The truck 1000 and/or trailer 1100 may be positioned approximately 15 feet from the turbine access door (not pictured), for example. These examples are not intended to be limiting; any vehicle and/or vehicle attachment can be employed in on-site maintenance of the turbines. For examples, boats, while not pictured, can also be used in a similar manner to bring supplies to certain wind turbine locations (e.g., off-shore wind turbine locations) for maintenance.

Various supplies can be transported to a turbine location. For example, the supplies on the truck and/or trailer may include pumps, hoses, heating elements, and various containers. In some embodiments, the containers may include a supply of cleaning fluid and a supply of replacement lubricant (e.g., grease). An additional container or containers may also be provided to receive and hold the old, used grease as it is purged from the main bearings during the cleaning process. The pump (or pumps) may be used to deliver the cleaning fluid to the main bearing to clean the main bearings by pushing the old grease out and displacing it. In some embodiments, the cleaning fluid may be a hot oil; for example, a cleaning oil in one of the containers on the truck could be heated by a heating element and then pumped up through the hose to the main bearing, according to some embodiments.

As an optional last step, any tools, hoses, and associated hardware may be lowered from the main bearing (e.g., down to the truck 1000 or trailer 1100) for storage or usage at another wind turbine.

Various examples have been described. These and other variations that would be apparent to those of ordinary skill in this field are within the scope of this disclosure.

What is claimed is:

1. A method of purging used grease from a main bearing of a main shaft of a wind turbine, the method comprising:
removing at least one bearing inspection plate from a main bearing cover of the wind turbine to provide a main bearing access opening without removing the main bearing cover from the main bearing;
affixing at least one adapter plate to the main bearing access opening;
delivering a cleaning fluid to the main bearing via the at least one adapter plate while causing the wind turbine main shaft to rotate; and
draining the used grease from a drain port in the main bearing cover.

2. The method of claim 1, wherein removing the at least one bearing inspection plate from the main bearing cover of the wind turbine comprises removing the at least one bearing inspection plate from a downwind side of a housing of the main bearing.

3. The method of claim 1, wherein the steps of delivering the cleaning fluid to the main bearing and draining the used grease from the drain port are repeated for at least two cycles.

4. The method of claim 3, wherein each of the at least two cycles comprises delivering 55 gallons of the cleaning fluid.

5. The method of claim 1, further comprising attaching a hydraulic line to the at least one adapter plate, the hydraulic line configured to deliver the cleaning fluid to the main bearing.

6. The method of claim 1, further comprising:
inserting a borescope into the main bearing access opening; and
inspecting at least one bearing using the borescope.

7. The method of claim 1, further comprising:
stopping the rotation of the main shaft of the wind turbine;
providing a supply of new grease to the main bearing while the rotation of the main shaft of the wind turbine is stopped; and
continuing to provide the supply of the new grease to the main bearing while causing the main shaft of the wind turbine to rotate.

8. A method of purging used grease from a main bearing of a main shaft of a wind turbine, the method comprising:
drilling at least one access hole through a main bearing cover of the wind turbine to provide a main bearing access opening without removing the main bearing cover from the main bearing;
affixing at least one fitting to the main bearing access opening;
delivering a cleaning fluid to the main bearing via the at least one fitting while causing the main shaft of the wind turbine to rotate; and
draining the used grease from a drain port in the main bearing cover.

9. The method of claim 8, further comprising affixing a manifold to the at least one fitting.

10. The method of claim 9, further comprising attaching a drill guide to the main bearing cover.

11. The method of claim 10, wherein the drill guide is attached at the 10 o'clock and/or 2 o'clock position.

12. The method of claim 8, further comprising attaching a hydraulic line to the at least one fitting, the hydraulic line configured to deliver a cleaning fluid to the main bearing.

13. The method of claim 8, further comprising:
inserting a borescope into the main bearing access opening; and
inspecting at least one bearing using the borescope.

14. The method of claim 8, further comprising inserting a plug into at least one of the at least one access holes.

15. A system for purging used grease from a main bearing of a main shaft of a wind turbine, the system comprising:
(a) at least one pump;
(b) at least one fluid line configured to deliver a cleaning fluid to the main bearing of the main shaft of the wind turbine, the at least one fluid line being in operable connection with the at least one pump and a main bearing access opening of the main bearing; and
(c) a drain port configured to drain used grease and/or cleaning fluid from the main bearing of the main shaft of the wind turbine.

16. The system of claim 15, further comprising a heating element configured to heat the cleaning fluid.

17. The system of claim 15, further comprising a drill guide configured to create the main bearing access opening.

18. The system of claim 15, further comprising an adapter plate configured to create the main bearing access opening.

19. The system of claim 15, wherein the system is configured for vehicular transportation.

20. The system of claim 15, further comprising a borescope insertable into the main bearing access opening.
